(19) United States
(12) Patent Application Publication
(10) Pub. No.: US 2008/0118697 A1
(43) Pub. Date: May 22, 2008

(54) STAMPER, READ-ONLY OPTICAL DISK, AND METHOD OF MAKING READ-ONLY OPTICAL DISK

(75) Inventors: Hideki Takahashi, Shizuoka (JP); Masatake Yagi, Shizuoka (JP); Kiyoshi Takii, Shizuoka (JP); Shinji Minegishi, Shizuoka (JP); Shinsuke Kishi, Saitama (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/748,039

(22) Filed: May 14, 2007

(30) Foreign Application Priority Data
May 24, 2006 (JP) 2006-143729

(51) Int. Cl. B32B 3/30

(52) U.S. Cl. 428/64.4; 264/293; 425/385

(57) ABSTRACT

A stamper for making a read-only optical disk includes an irregular pattern for forming embossed pits based on recording information and an irregular pattern for forming dummy irregularities. The irregular pattern for the embossed pits is arranged in a region corresponding to an information area for recording information in the read-only optical disk. The irregular pattern for the dummy irregularities is arranged in a region corresponding to an area between the information area and the outer periphery of the disk.

### CROSS REFERENCES TO RELATED APPLICATIONS

The present invention contains subject matter related to Japanese Patent Application JP 2006-143729 filed in the Japanese Patent Office on May 24, 2006, the entire contents of which are incorporated herein by reference.

### BACKGROUND OF THE INVENTION

1. Field of the Invention

The present invention relates to a stamper used for making a read-only optical disk, the made read-only optical disk, and a method of making the read-only optical disk, and in particularly, to a technique suitable for high density optical disks.

2. Description of the Related Art

As disclosed in Japanese Unexamined Patent Application Publication No. 2003-109252, in a general read-only optical disk, a read signal is switched between a high (H) level and a low (L) level synchronously with a clock signal providing a reference unit time. Information is recorded on the basis of the combination of the duration of H-level state and that of L-level state. In the read-only optical disk, the H-level states and the L-level states are generally expressed by a series of pits arranged in a track. In other words, the pit series including pits and lands between adjacent pits is scanned with a laser beam, so that the H-level and L-level read signals are obtained.

As disclosed in Japanese Unexamined Patent Application Publication No. 2002-304775, in mastering processing for a read-only optical disk having a series of so-called embossed pits, a disk substrate is exposed to a laser beam to form a series of pits based on recording data, so that a disk master is produced. A stamper is made using the disk master. Optical disks are mass-produced using the stamper.

### SUMMARY OF THE INVENTION

Precisely transferring a pit pattern of a stamper is required for forming recording pits of a CD (compact disc) or a DVD (digital versatile disc). Accordingly, high precision molding technique is necessary.

The track pitch between pit strings constituting a series of pits in a Blu-ray Disc (registered trademark), serving as a higher-density optical disk developed recently, is 0.32 μm which is about half that of the DVD. The width, length, and depth of a pit are smaller than those of a pit in the DVD. Upon molding a disk substrate using a stamper, pit deformation easily occurs on the molded substrate. Slight pit deformation may seriously affect read signals.

FIGS. 14A to 14C are diagrams explaining pit deformation. FIG. 14A shows normal pits 1 formed in making a disk substrate using a stamper.

However, in an inner peripheral portion of the disk substrate, the pits 1 are easily deformed such that the pits each have a tail extending to the inner periphery of the disk substrate as shown in FIG. 14B. Moreover, in an outer peripheral portion of the disk substrate, the pits 1 are easily deformed such that the pits each have a tail extending to the outer periphery of the disk as shown in FIG. 14C. In the following description, such pit deformation will be called pit tailing.

The pit tailing depends on the degree of contact between the stamper and the disk substrate during molding. For example, when the degree of contact therebetween is low, pit tailing easily occurs by shrinkage of a resin in a mold caused by cooling or upon releasing a mold clamping force. On the contrary, when the degree of contact therebetween is too high, pit tailing easily occurs upon separating the stamper from the disk substrate.

Therefore, the appropriate degree of contact therebetween is necessary. Since a higher-density optical disk, such as a Blu-ray Disc, has very small pits, it is difficult to obtain the desired degree of contact between a stamper and a disk substrate during molding. Unfortunately, pit tailing easily occurs.

It is desirable to provide a read-only optical disk, serving as a high density optical disk, which is made without pit deformation and is capable of achieving good reproducibility.

According to an embodiment of the present invention, a stamper for making a read-only optical disk includes an irregular pattern for forming embossed pits based on recording information and an irregular pattern for forming dummy irregularities. The irregular pattern for the embossed pits is arranged in a region corresponding to an information area for recording information in the read-only optical disk. The irregular pattern for the dummy irregularities is arranged in a region corresponding to an area between the information area and the outer periphery of the disk.

According to this embodiment, the irregular pattern for forming the dummy irregularities may be arranged in a region corresponding to an area between the information area and the inner periphery of the disk.

According to this embodiment, the dummy irregularities formed on the read-only optical disk may be dummy pit strings and the irregular pattern for forming the dummy irregularities may be designed such that each dummy pit of the dummy pit strings has a depth greater than that of each embossed pit in the information area and the track pitch between the dummy pit strings is wider than that between embossed pit strings in the information area.

The dummy irregularities formed on the read-only optical disk may be dummy pit strings and the irregular pattern for forming the dummy irregularities may be designed such that dummy pits of the dummy pit strings are each an embossed pit having a predetermined length.

The irregular pattern for forming the dummy irregularities may be designed so as to provide a dummy groove in the read-only optical disk.

According to another embodiment of the present invention, a read-only optical disk, on which information is recorded using embossed pits in an information area for recording information, includes dummy irregularities arranged between the information area and the outer periphery of the disk.

According to this embodiment, the dummy irregularities may be arranged between the information area and the inner periphery of the disk.

According to this embodiment, the dummy irregularities may be dummy pit strings, each dummy pit of the dummy pit strings may have a depth greater than that of each embossed pit in the information area, and the track pitch between the dummy pit strings may be wider than that between embossed pit strings in the information area.

The dummy irregularities may be dummy pit strings and dummy pits of the dummy pit strings may be each an embossed pit having a predetermined length.

The dummy irregularities may provide a dummy groove.

According to this embodiment, the embossed pits and the dummy irregularities may be arranged on a first surface of a disk substrate of the disk, a second surface of the disk substrate may be satin finished, a reflective layer and a light-transmissive layer (cover layer) may be arranged on the first surface, and a printing layer may be arranged on the second surface. Preferably, the roughness of the satin-finished second surface is in the range of 0.5 μm to 5 μm.

According to another embodiment of the present invention, a method of making a read-only optical disk includes the steps of (a) producing a disk master such that an irregular pattern for embossed pits based on recording information is formed in a region corresponding to an information area for recording information in a read-only optical disk and an irregular pattern for dummy irregularities is formed in a region corresponding to an area between the information area and the outer periphery of the disk, (b) producing a stamper using the disk master, and (c) producing a read-only optical disk using the stamper.

According to this embodiment, the step (a) includes the substeps of producing a disk substrate using a mold having a first segment and a second segment, forming a reflective layer and a light-transmissive layer (cover layer) on a first surface of the disk substrate, and forming a printing layer on a second surface of the disk substrate. The first segment of the mold has an inner surface on which the stamper produced in the step (b) is arranged. The second segment of the mold has an inner surface that is satin finished. The first surface of the disk substrate has the embossed pits and the dummy irregularities. The second surface of the disk substrate is satin finished.

Preferably, the roughness of the satin-finished inner surface of the second segment of the mold is in the range of 0.5 μm to 5 μm.

In the above-described embodiments, the dummy irregularities, serving as dummy pits, are arranged in an area outside the information area of a read-only optical disk, i.e., the area where normal pits are not arranged.

The information area is defined for recording main data, such as audio/video content, various files, or a program, management information for the main data, and physical information and identification information related to the disk. The information area includes areas that mean something to an optical disk reproducing apparatus, such as a lead-out area close to the outer periphery of the disk and a burst cutting area (BCA) close to the inner periphery thereof.

In other words, an area outside the information area is a region generally containing no pits or groove having special significance to the recording operation and the reproducing operation of an optical disk recording and reproducing apparatus.

In accordance with one of the above-described embodiments of the present invention, the stamper has the irregular pattern for forming the dummy irregularities in an area outside the information area, at least an area located between the information area and the outer periphery of an optical disk. In addition, the dummy irregularities may be arranged in an area between the information area and the inner periphery of the optical disk. In the use of the stamper, the appropriate degree of contact between the stamper and a disk substrate, serving as a read-only optical disk, can be obtained.

Further, in accordance with another one of the embodiments of the present invention, the disk substrate has the first surface on which embossed pits and the dummy irregularities are arranged and the second surface which is satin finished. For example, in order to produce a disk substrate, the stamper having the above-described irregular pattern is arranged in the first segment of the mold so that the embossed pits and the dummy irregularities are formed on the first surface of the disk substrate. The inner surface of the second segment of the mold is satin finished so that the second surface of the disk substrate is satin finished. The satin-finished inner surface of the second segment of the mold provides the appropriate degree of contact between the stamper and the disk substrate during molding of the disk substrate using the mold and the stamper, thus preventing pit tailing caused by shrinkage of a resin in the mold during cooling or upon releasing a mold clamping force.

The “satin-finished” surface has fine irregularities uniformly formed by mechanical or chemical treatment as defined in JIS (Japanese Industrial Standards).

The roughness of the satin-finished surface lies in the range of 0.5 μm to 5 μm. A roughness of 0.5 μm is the minimum value which gives the effect of preventing pit tailing and a roughness of 5 μm is the maximum value which provides the good appearance of the label surface of a disk substrate after printing processing.

According to the present invention, upon molding a substrate of a high density optical disk in which the size of each pit is very small and the track pitch between pit strings is narrow, the appropriate degree of contact between a stamper and the disk substrate is obtained. Advantageously, pit tailing in the information area can be prevented and pit transfer precision can be increased. Consequently, a read-only optical disk made in this manner has normal embossed pits, thus ensuring stable read signal characteristics.

### BRIEF DESCRIPTION OF THE DRAWINGS

FIG. 1 is a diagram explaining the area configuration of a read-only optical disk according to an embodiment of the present invention;

FIGS. 2A and 2B are diagrams explaining normal pits and dummy pits according to a first example of the embodiment;

FIG. 3 is a diagram explaining a stamper and a disk substrate in accordance with the first example of the embodiment;

FIGS. 4A and 4B are diagrams explaining normal pits and dummy pits according to a second example of the embodiment;

FIGS. 5A and 5B are diagrams explaining normal pits and a dummy groove in accordance with the embodiment;

FIGS. 6A to 6J are diagrams explaining a method of making an optical disk in accordance with the embodiment;

FIG. 7 is a diagram explaining the structure of a mastering apparatus in accordance with the embodiment;

FIG. 8 is a diagram explaining a laser emission waveform of the mastering apparatus;

FIG. 9 is a flowchart of mastering processing in accordance with the embodiment;

FIGS. 10A and 10B are diagrams explaining molding of a disk substrate in accordance with the embodiment;

FIGS. 11A to 11C are diagrams explaining the layered structure of the disk substrate in accordance with the embodiment;

FIGS. 12A to 12C are diagrams explaining molding of a disk substrate in accordance with another embodiment of the present invention;

FIGS. 13A to 13C are diagrams explaining the layered structure of an optical disk in accordance with the embodiment shown in FIGS. 12A to 12C; and

FIGS. 14A to 14C are diagrams explaining pit tailing.

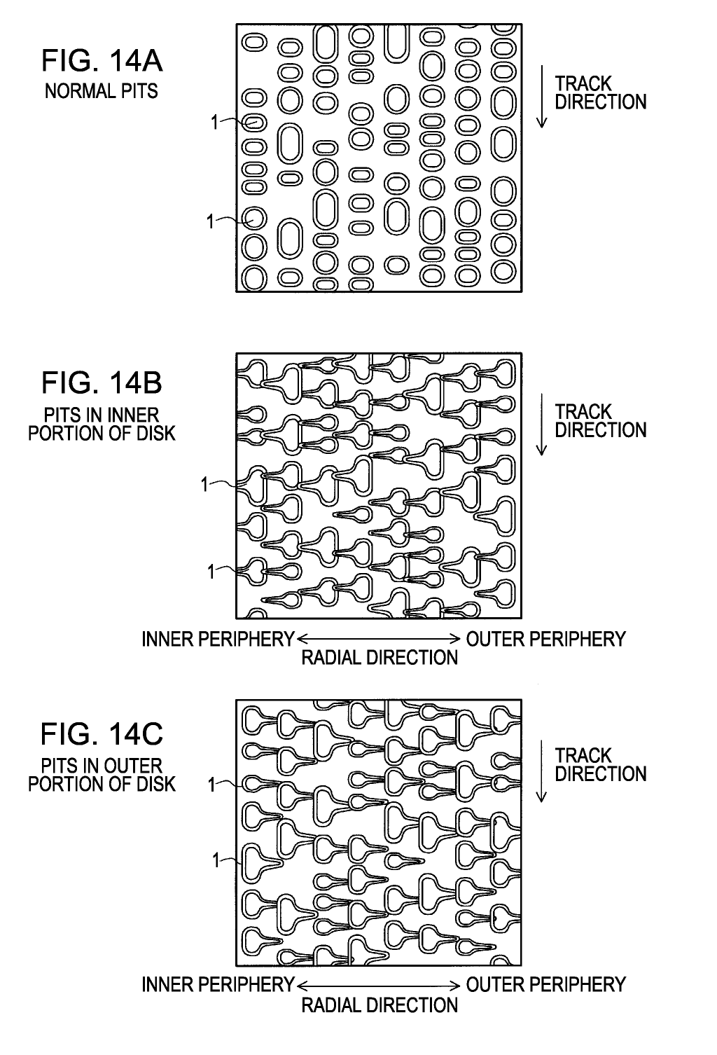

### DESCRIPTION OF THE PREFERRED EMBODIMENTS

An embodiment of the present invention will be described below.

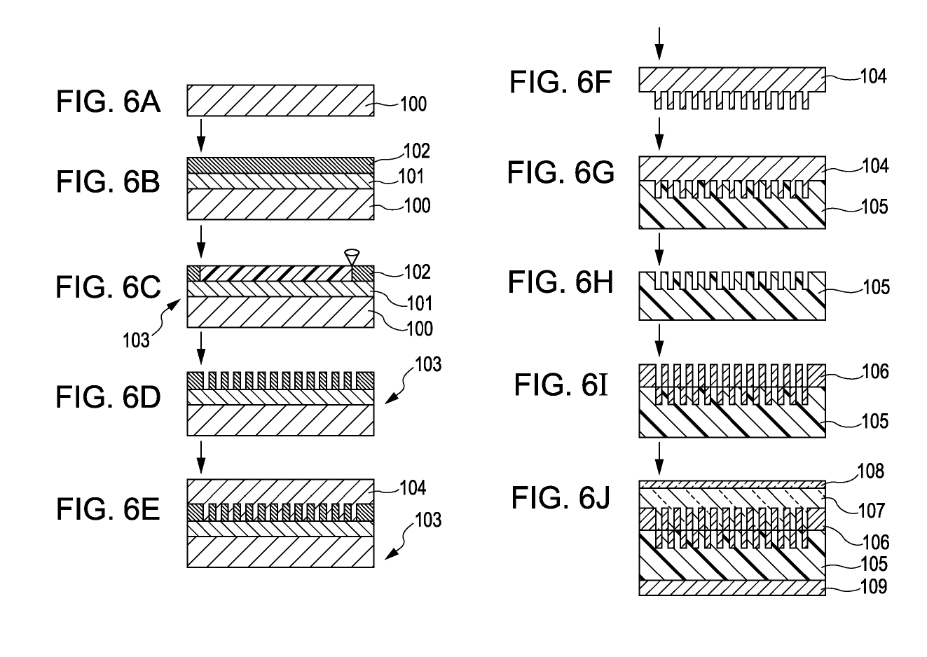

A method of making a read-only optical disk will now be described with reference to FIGS. 6A to 6J.

FIG. 6A shows a substrate 100 constituting a disk master. First, a resist layer 102 made of, for example, an inorganic resist is evenly formed on the substrate 100 by sputtering. FIG. 6B shows the above-described resist layer forming step. A phase transition mastering (PTM) technique using an inorganic resist will be described later as mastering processing of making a disk master. In this case, incomplete oxides of transition metals are available as a material for the resist layer 102. Specifically, the transition metals include titanium, vanadium, chromium, manganese, iron, niobium, copper, nickel, cobalt, molybdenum, tantalum, tungsten, zirconium, ruthenium, and silver.

In order to improve the exposure sensitivity of the resist layer 102, a predetermined intermediate layer 101 may be disposed between the substrate 100 and the resist layer 102 as shown in FIG. 6B. The thickness of the resist layer 102 may have any value, preferably, in the range of 10 nm to 80 nm.

Subsequently, the resist layer 102 is selectively exposed so as to have a series of pits, serving as a signal pattern, by means of a mastering apparatus which will be described later. FIG. 6C shows the above-described resist layer exposing step. The resist layer 102 is developed, thus making a disk master 103 having a predetermined irregular pattern (series of pits or pit strings). FIG. 6D shows the above-described resist layer developing step.

A metallic nickel layer is deposited on the irregular pattern of the disk master 103 as shown in FIG. 6E. This layer is peeled off from the disk master 103 and is then subjected to a predetermined process, thus making a stamper 104 on which the irregular pattern of the disk master 103 is transferred. FIG. 6F shows the stamper 104.

A disk substrate 105 made of polycarbonate, a thermoplastic resin, is molded using the stamper 104 by injection molding as shown in FIG. 6G.

After that, the stamper 104 is separated from the resin disk substrate 105 as shown in FIG. 6H. A reflective layer 106 made of, for example, a silver alloy, is formed on an irregular surface of the disk substrate 105 as shown in FIG. 6I and is then overlaid with a light-transmissive layer (cover layer) 107 having a thickness of about 0.1 mm. The light-transmissive layer 107 is covered with a hard coat 108. On the other hand, a printing layer 109 is formed on the opposite surface, serving as a label surface, of the disk substrate 105 from the reflective layer 106. In this manner, an optical disk is completed as shown in FIG. 6J. In some cases, the hard coat 108 may be omitted.

According to the above-described method, the following read-only optical disk is made in accordance with the present embodiment.

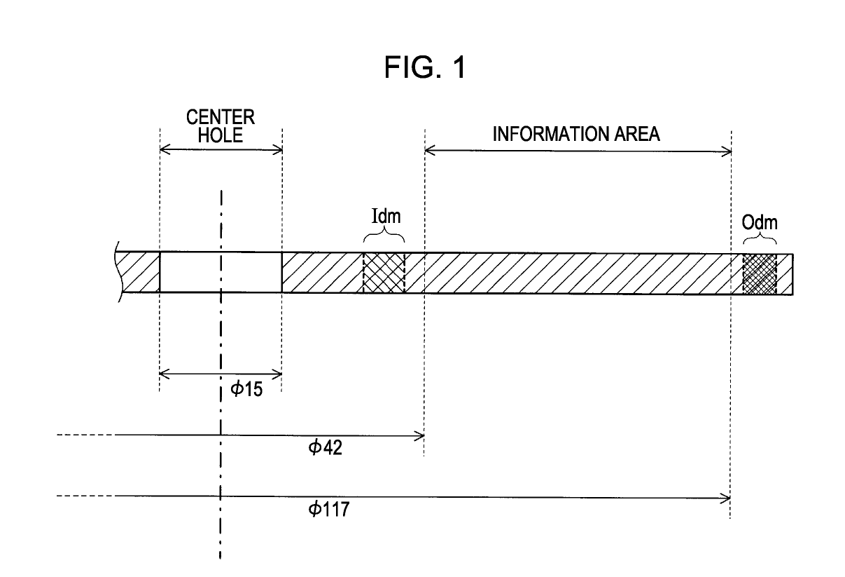

FIG. 1 shows the area configuration of a read-only optical disk according to the present embodiment.

Referring to FIG. 1, an optical disk based on, for example, the Blu-ray Disc format has a diameter of 12 cm and has a center hole having a diameter of 15 mm.

An annular region in the range of 42 mm to 117 mm in diameter of the disk is defined as an information area.

The information area includes, for example, a BCA, a lead-in area, a data area, and a lead-out area in this order from the inner periphery of the disk. In the BCA, pits are radially arranged, thus providing a bar-code-like radial pattern. For example, disk identification information is recorded in the BCA. In the lead-in area, physical information concerning the disk, recommendation information related to the operation of a reproducing apparatus, area information, and management information related to content data or file data are recorded. In the data area, main data, such as content data or file data, is recorded. The lead-out area serves as a buffer area close to the outer periphery of the disk.

According to the Blu-ray Disc format, the thickness of a disk excluding the information area is defined. However, pit formation is not particularly defined.

In the present embodiment, an outer dummy area Odm is arranged outside the information area, i.e., between the information area and the outer periphery of the disk. In addition, an inner dummy area Idm is arranged inside the information area, i.e., between the information area and the inner periphery of the disk.

In each of the outer and inner dummy areas Odm and Idm, dummy irregularities, such as dummy pits or a dummy groove, are arranged.

Those dummy irregularities are formed on a surface of the read-only optical disk by transferring the irregular pattern of the stamper 104 to the surface of the disk. The irregular pattern prevents pit tailing during molding of the disk substrate.

Two examples of the irregular pattern will now be described.

In a first example, an irregular pattern was formed on the stamper 104 so that dummy pits were arranged in the range of 38 mm to 41 mm in diameter of a molded disk substrate and were further arranged in the range of 117.5 mm to 120.0 mm in diameter thereof. In other words, the range of 38 mm to 41 mm in diameter of a read-only optical disk corresponds to the inner dummy area Idm in FIG. 1 and the range of 117.5 mm to 120.0 mm in diameter thereof corresponds to the outer dummy area Odm in FIG. 1. The disk substrate 105 was molded using the stamper 104 having the above-described pattern.

The dummy pits formed by the irregular pattern of the stamper 104 have the following physical characteristics:
The lengths of the dummy pits lie within the range of 2T to 8T (T: channel clock period) in keeping with the Blu-ray Disc specifications. A signal pattern of the dummy pits includes a series of pits of 2T to 8T in length.
The track pitch between adjacent dummy pit strings is 0.64 μm. In the information area of a Blu-ray Disc, the track pitch between adjacent pit strings is generally 0.32
The depth of each dummy pit is 70 nm. In the information area of the Blu-ray disc, the depth of each pit is generally 50 nm.

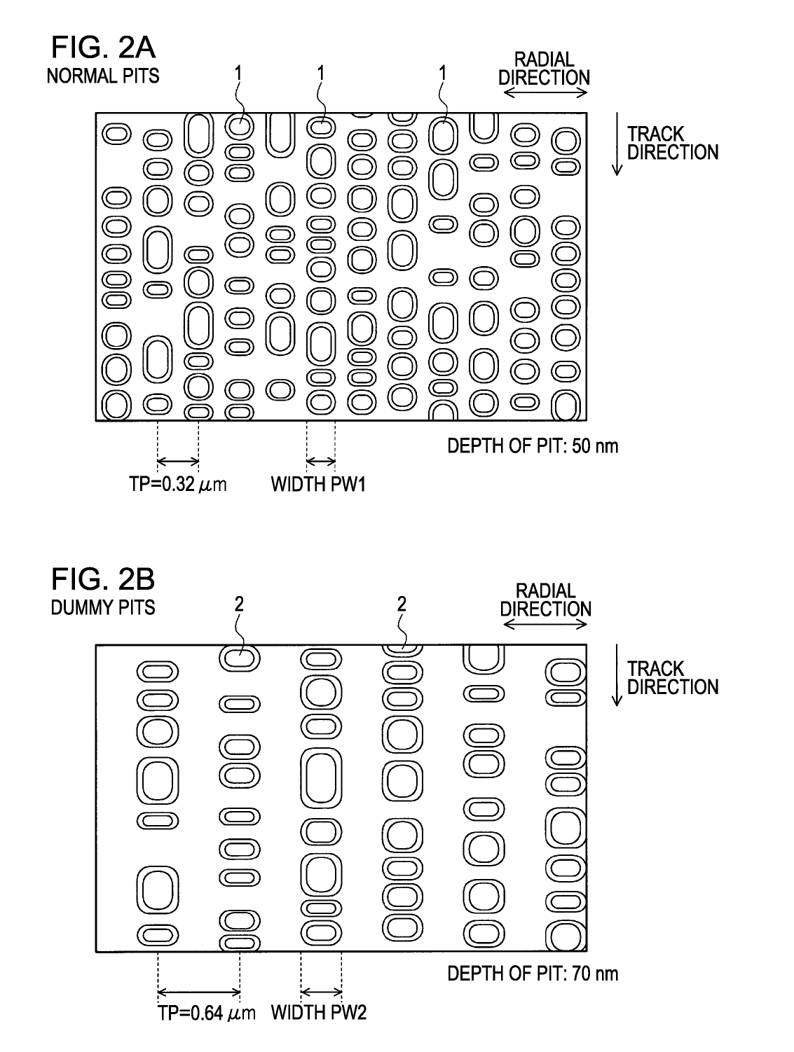

FIGS. 2A and 2B illustrate pits formed using the stamper of the first example. FIG. 2A shows strings of normal pits 1, i.e., embossed pits arranged in the information area. In accordance with the Blu-ray Disc format, the strings of pits 1 of 2T to 8T in length based on modulation signals of recording data are arranged on the conditions that the track pitch is 0.32 μm and the depth of each pit is 50 nm.

FIG. 2B shows strings of dummy pits 2 arranged in each of the outer dummy area Odm and the inner dummy area Idm. As described above, the track pitch is 0.64 μm and the depth of each dummy pit is 70 nm.

To form a dummy pit 2 whose depth is greater than that of each normal pit 1, the output power of a laser is increased during exposure of a disk master as will be described later. Thus, the depth of the dummy pit 2 is increased and the width PW2 of the dummy pit 2 is wider than the width PW1 of the normal pit 1. This allows each pit in the dummy areas Odm and Idm to have a sufficient capacity.

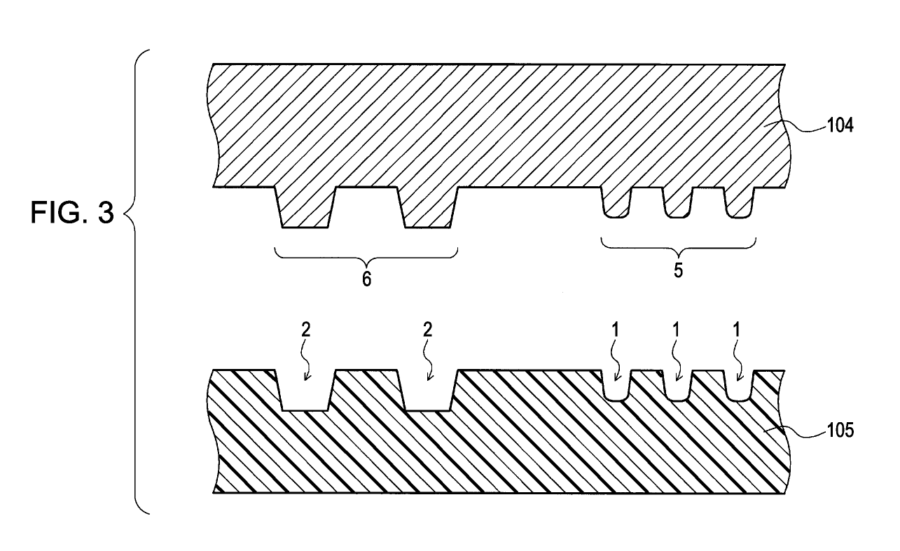

FIG. 3 schematically shows the disk substrate 105 and the stamper 104, the disk substrate having the normal pits 1 and the dummy pits 2 formed by the stamper 104. The stamper 104 has an irregular pattern 6 for forming the dummy pits 2 and another irregular pattern 5 for forming the normal pits 1. In the use of the stamper 104, a read-only optical disk having the strings of pits shown in FIGS. 2A and 2B is made.

The read-only optical disk molded using the stamper 104 of the first example was played to measure the jitter thereof. The jitter over the whole disk was 5.7% or lower, i.e., the favorable jitter was obtained. In other words, there was no deterioration in characteristics of read signals caused by tailing the normal pits 1 in the information area.

Furthermore, a sampling inspection was performed on 10,000 optical disks successively molded in order to recognize molding stability. As a result, there was no deterioration in jitter.

In a second example, an irregular pattern was formed on the stamper 104 so that dummy pits were arranged in the range of 22 mm to 38 mm in diameter of a molded disk substrate and were further arranged in the range of 117.5 mm to 120.0 mm in diameter thereof. In other words, the range of 22 mm to 38 mm in diameter of a read-only optical disk corresponds to the inner dummy area Idm in FIG. 1 and the range of 117.5 mm to 120.0 mm in diameter thereof corresponds to the outer dummy area Odm in FIG. 1. The disk substrate 105 was molded using the stamper 104 having the above-described pattern.

The dummy pits formed by the irregular pattern of the stamper 104 have the following physical characteristics:
The dummy pits, constituting dummy pit strings, each have a length of 8T. In other words, the dummy pits each have the maximum length among the lengths of 2T to 8T based on the Blu-ray Disc specifications.
The track pitch between adjacent dummy pit strings is 0.32 μm and the depth of each dummy pit is 50 nm. In other words, the track pitch therebetween is the same as that between normal pit strings in the information area and the depth of each dummy pit is the same as that of each normal pit therein.

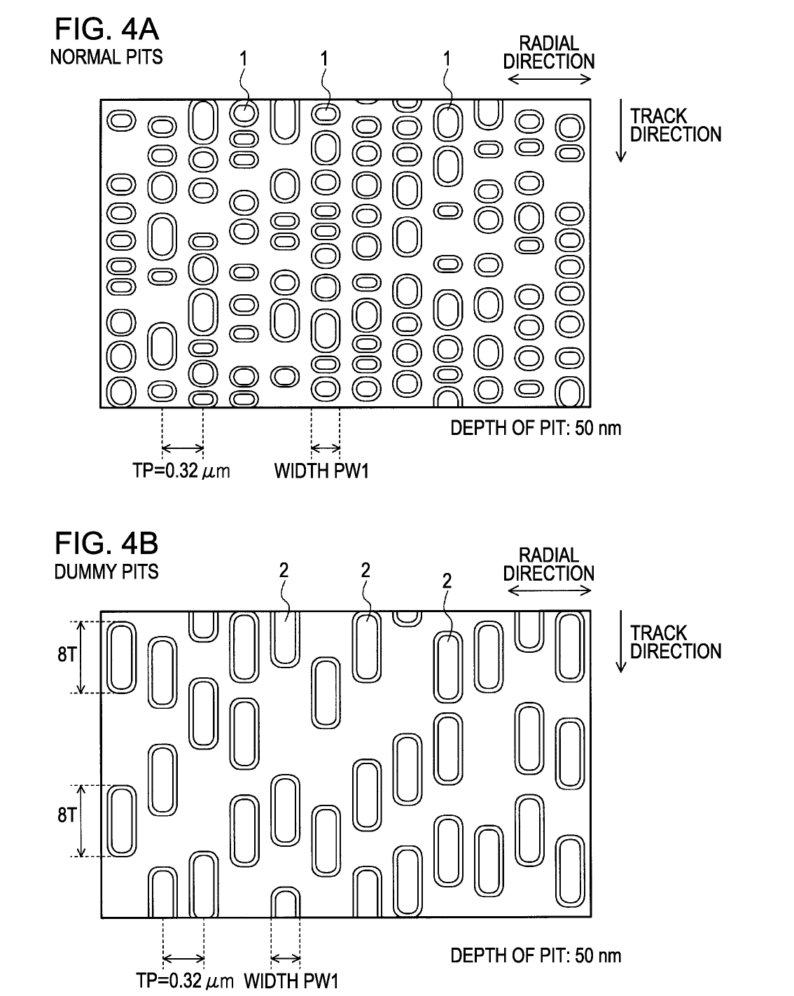

FIGS. 4A and 4B illustrate pits formed using the stamper of the second example. FIG. 4A shows strings of normal pits 1 arranged in the information area. FIG. 4B shows strings of dummy pits 2 arranged in each of the outer dummy area Odm and the inner dummy area Idm.

As will be understood from comparison between FIGS. 4A and 4B, the dummy pit strings have the same track pitch as that of the normal pit strings and the dummy pits each have the same width and depth as those of the normal pits. Each dummy pit 2 has a length of 8T that is the maximum length among the lengths of the normal pits. This allows each dummy pit in the outer and inner dummy areas Odm and Idm to have a sufficient capacity.

The read-only optical disk molded using the stamper 104 of the second example was played to measure the jitter thereof. The jitter over the whole disk was 5.7% or lower, i.e., the favorable jitter was obtained. There was no deterioration in characteristics of read signals caused by tailing the normal pits 1 in the information area.

In addition, a sampling inspection was performed on 10,000 optical disks successively molded in order to recognize molding stability. As a result, there was no deterioration in jitter.

As described in the above first and second examples, the irregular pattern for dummy pits is formed on the stamper 104 and read-only optical disks each having the dummy pits 2 arranged in areas excluding the information area on a surface of the disk are made using the stamper 104, so that the quality of read signals can be prevented from deteriorating due to pit tailing.

A comparative example will now be described. In the comparative example, a dummy pit pattern was arranged in the range (corresponding to the inner dummy area Idm) of 38 mm to 41 mm in diameter of a stamper for molding a Blu-ray Disc such that the dummy pit pattern complied with the Blu-ray Disc specifications, i.e., the track pitch between adjacent dummy pit strings was 0.32 μm and the depth of each dummy pit was 50 nm.

The dummy pits were used to express characters or a bar code for verification of the product number of the stamper using the contrast between pits and mirror portions.

In addition, the dummy pit pattern was designed so that dummy pits were not arranged outside the information area.

The measured jitter of a read-only optical disk, molded using this stamper of the comparative example, in an intermediate area of the disk was 5.7% or lower, i.e., a favorable value. However, an unstable jitter was measured in each of an inner area inside the information area and an outer area outside the information area. In some cases, a significantly deteriorated jitter, e.g., a jitter of 10% or higher was measured. Since there was little margin for molding conditions, stable production was difficult. In observation of pits in a portion having a deteriorated jitter using a scanning electron microscope (SEM), pit tailing was confirmed in this portion.

As the result, the followings were confirmed: When the stamper 104 is made such that dummy pits are appropriately arranged as described in the first and second examples, pit tailing can be prevented during molding of a disk substrate and a deterioration in signal characteristics caused by molding with pit tailing can also be prevented. Furthermore, it is effective to arrange the outer dummy area Odm outside the information area, i.e., between the information area and the outer periphery of a disk. It is effective to allow each dummy pit to have a sufficient capacity. In the first and second examples, the dummy pits 2 are arranged in the outer dummy area Odm. In the first example, since the depth of each dummy pit 2 is greater than that of each normal pit 1 and the width of the dummy pit 2 is wider than that of the normal pit 1, the dummy pits 2 each have a capacity larger than that of the normal pit 1. Consequently, the dummy pits 2 each serve as an embossed pit having a larger capacity than that of the normal pit 1. In the second example, although the depth and width of each dummy pit 2 are the same as those of the normal pit 1, the length of the dummy pit 2 is 8T that is the longest length among the lengths of the normal pits 1. Thus, the dummy pits 2 each have a sufficient capacity.

The dummy irregularities capable of preventing pit tailing are not limited to the dummy pits 2 in the first and second examples.

For example, a dummy groove may be used instead of the dummy pits 2.

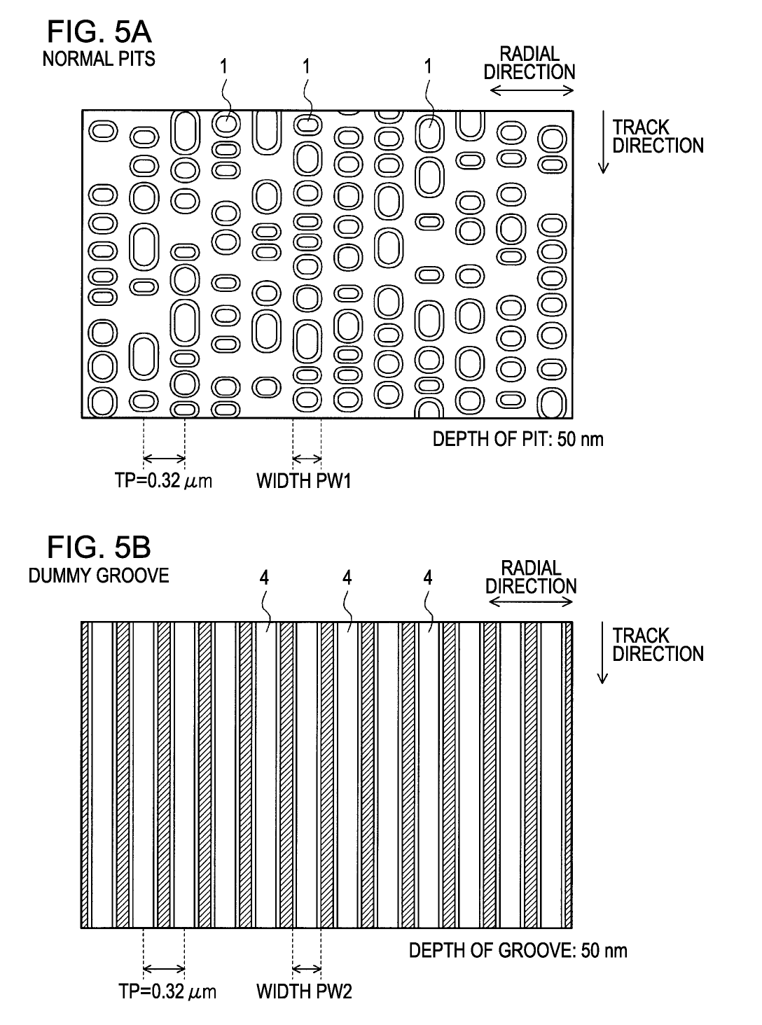

FIG. 5A shows the normal pits 1 in the information area. FIG. 5B shows a dummy groove 4 which is arranged in the outer dummy area Odm, alternatively, in each of the outer dummy area Odm and the inner dummy area Idm. The dummy groove 4 is equivalent to the extended dummy pit 2, for example, whose length of 8T in the above-described second example is remarkably elongated. Accordingly, when the dummy groove 4 is arranged on the stamper 104 such that the track pitch between adjacent dummy groove segments is set to 0.32 μm in the same way as the second example, i.e., an irregular pattern for formation of the dummy groove 4 is formed on the stamper 104 on the similar conditions as those in the second example, the same advantages as those of the second example can be obtained.

The ranges for the dummy areas Odm and Idm for formation of dummy irregularities, such as the dummy pits 2 or the dummy groove 4, are not limited to those in the above-described examples.

The present embodiment has been described with respect to the Blu-ray Disc as an example. The present invention is applicable to other optical disks and is particularly suitable for high density optical disks.

As described with reference to FIGS. 6A to 6J, the stamper 104 is made using the disk master 103. In other words, in making the stamper 104 having an irregular pattern for forming the above-described dummy irregularities, the irregular pattern is exposed during making of the disk master 103.

Mastering processing (disk master production) for the stamper 104 and the optical disk according to the above-described first example will now be described below.

To make a ROM disk, such as a CD-ROM or a DVD-ROM, a disk master covered with a photoresist is provided. The disk master is irradiated with a laser beam emitted from a laser source, such as a gas laser, through a mastering apparatus (master exposure apparatus), thus forming an exposure pattern corresponding to pits. In this case, the intensity of the laser beam from the laser source, serving as a continuous-gas laser source, is modulated by, for example, an acousto-optical modulator (AOM). The laser beam having the modulated intensity is guided to the disk master through an optical system and the disk master is exposed using the laser beam. In other words, a pit modulation signal, e.g., an NRZ (Non Return to Zero) modulation signal is supplied to the AOM and the intensity of the laser beam is subjected to modulation for the pit pattern by the AOM, so that only part, corresponding to the pit pattern, of the disk master is exposed to the laser beam.

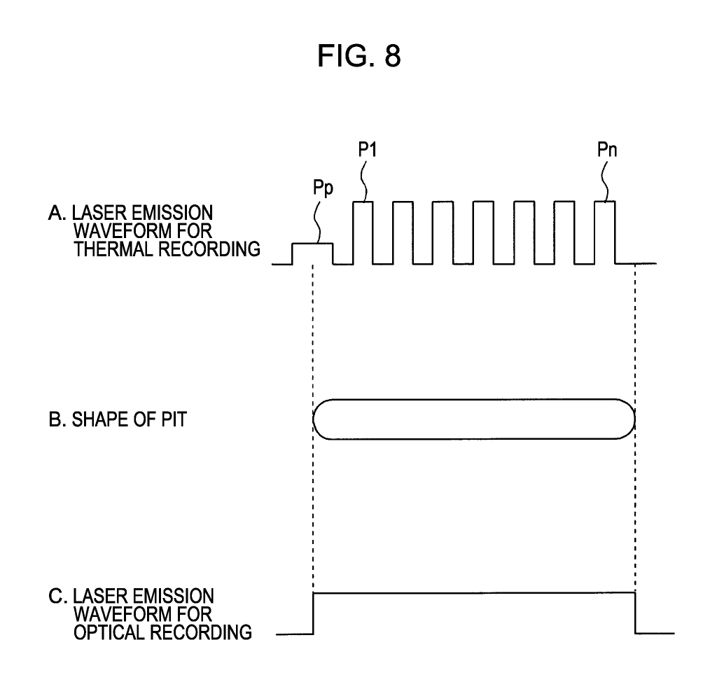

Referring to FIG. 8, part B shows the shape of a pit and part C shows the intensity of a laser beam modulated by the AOM. Since exposure of the photoresist on the disk master is so-called optical recording, a portion exposed to the laser beam shown in part C of FIG. 8 becomes a pit.

On the other hand, an exposure technique, known as phase transition mastering (PTM), has been developed. According to this technique, a disk master covered with an inorganic resist is irradiated with a laser beam emitted from a semiconductor laser, thus achieving thermal recording.

In this case, in order to suppress the accumulation of heat by laser irradiation to make the widths of pits uniform, the disk master is generally exposed to a pulsed beam as shown in part A of FIG. 8. In other words, an NRZ modulation signal, generally synchronized with a clock, is converted into a pulsed modulation signal having a period shorter than a clock period in accordance with the duration of the H-level state of the NRZ signal. Electric power is supplied to the semiconductor laser whose power can be directly modulated synchronously with the converted pulsed modulation signal. Thus, the laser outputs power corresponding to a pulse Pp for pre-heating and pulses P1 to Pn for heating in accordance with the length of the pit as shown in part A of FIG. 8.

The present embodiment may use either of the above-described exposure techniques. As an example, a case using mastering according to the PTM technique will now be described.

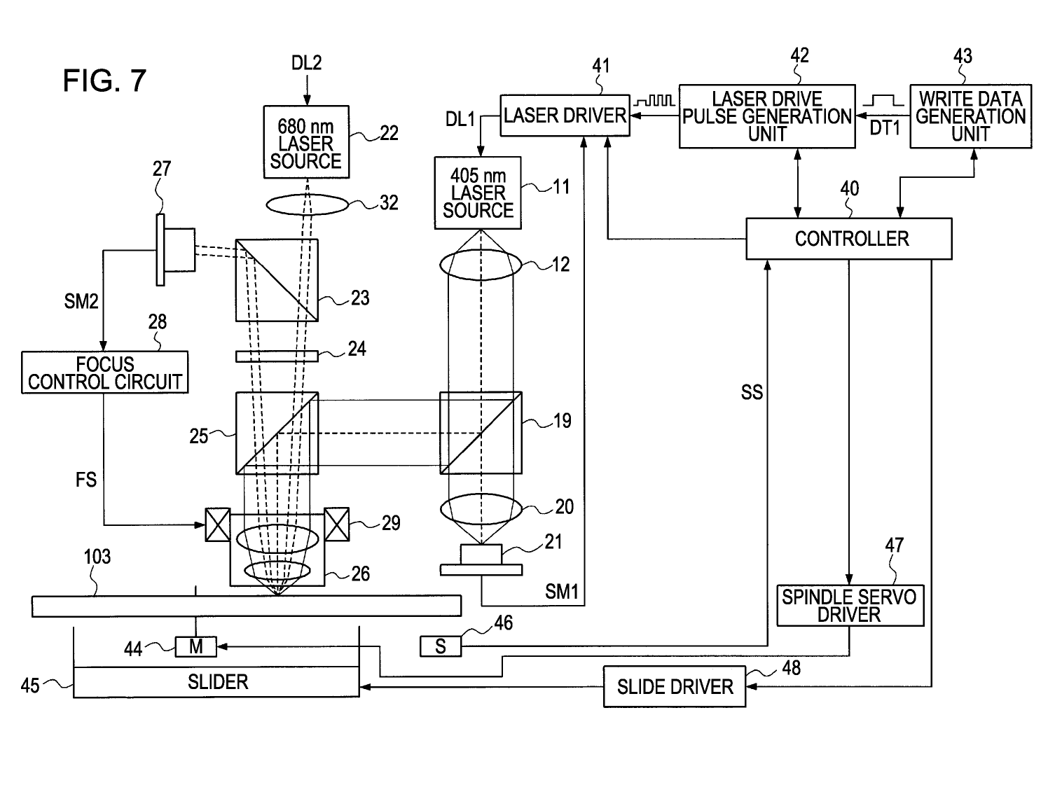

FIG. 7 shows an example of the structure of a mastering apparatus. The mastering apparatus performs a thermal recording process of irradiating the disk master 103, which is covered with the inorganic resist as described above, with a laser beam, thus forming a pit pattern.

A laser source 11, serving as a semiconductor laser, outputs a laser beam having a wavelength of, for example, 405 nm. A laser drive signal DL1, obtained by converting an NRZ modulation signal based on, for example, RLL(1-7)pp modulation into a pulsed modulation signal as shown in part A of FIG. 8, is supplied to the laser source 11. The laser source 11 outputs a beam in accordance with the laser drive signal DL1.

The laser beam emitted from the laser source 11 is collimated by a collimating lens 12. The collimated beam reaches a beam splitter 19. The beam splitter 19 splits the beam into a transmitting component and a reflected component. The transmitting component is applied to a photodetector 21 through a lens 20.

The photodetector 21 outputs an intensity monitor signal SM1 based on the level (quantity of light) of the received component, i.e., the intensity of the component.

The component reflected by the beam splitter 19 is incident on a dichroic mirror 25. In this case, the dichroic mirror 25 reflects light in a wavelength range including 405 nm and transmits light in a wavelength range including 680 nm. Accordingly, the laser beam component reflected through the beam splitter 19 is reflected by the dichroic mirror 25 and is then applied to the surface of the disk master 103, covered with the inorganic resist, through an infinity-corrected objective lens 26. In other words, an exposure pattern, serving as pit strings, is formed on the disk master 103 by thermal recording using the laser beam emitted from the laser source 11.

A laser source 22 emits a laser beam for focusing control using an off-axis method and includes a semiconductor laser for emitting a laser beam having a wavelength of, for example, 680 nm. The laser source 22 continuously emits a laser beam on the basis of a laser drive signal DL2.

The emitted laser beam having a 680 nm wavelength passes through a lens 32, a polarizing beam splitter (PBS) 23, a λ/4 wave plate 24, and the dichroic mirror 25. The laser beam is applied to the disk master 103 through the objective lens 26.

Return light from the disk master 103 passes through the objective lens 26, the dichroic mirror 25, and the λ/4 wave plate 24 and reaches the PBS 23. Since the laser beam passes the λ/4 wave plate 24 on the going path and the returning path, i.e., two times, the plane of polarization is rotated by 90°. Thus, the return light is reflected by the PBS 23. The return light reflected by the PBS 23 is received by a position sensor diode 27.

The position sensor diode 27 is designed so that return light is applied to the center of the diode in a focus on state, i.e., when the objective lens 26 is controlled in a right focus position. The position sensor diode 27 outputs a signal SM2, serving as information on the light receiving position. In other words, the signal SM2 indicating the amount of deviation of the light receiving position from the center of the position sensor diode 27 serves as a focus error signal. The position sensor diode 27 supplies the focus error signal to a focus control circuit 28.

The focus control circuit 28 generates a servo drive signal FS for an actuator 29 on the basis of the signal SM2, i.e., the focus error signal. The actuator 29 carries the objective lens 26 movably in the focusing direction. The actuator 29 moves the objective lens 26 close to or away from the disk master 103 in accordance with the servo drive signal FS, thus performing focus servo control.

At that time, the exposure laser beam, emitted from the laser source 11, having a 405 nm wavelength is focused on the disk master 103 through the objective lens 26. Since the disk master 103 includes a silicon wafer overlaid with the inorganic resist composed of a metal oxide, the disk master 103 absorbs a laser beam having a 405 nm wavelength, so that part in the vicinity of the center of a portion irradiated with the beam, i.e., the part heated at a high temperature is polycrystallized. As described with reference to FIG. 6D, the exposed disk master 103 is developed using an alkaline developer, such as NMD3, so that the exposed portion alone is eluted. Thus, pits having a desired shape are formed.

On the other hand, the laser beam for focus control has a 690 nm wavelength that has no exposure sensitivity. Accordingly, the laser beam does not affect the exposure.

The laser drive signal DL1 for the laser source 11 is generated by a recording data generation unit 43, a laser drive pulse generation unit 42, and a laser driver 41.

The write data generation unit 43 outputs write data DT1 to be recorded as an exposure pattern for pits onto the disk master 103. For example, the write data generation unit 43 outputs main data, such as a video signal and an audio signal, and other data, such as physical information and management information. In addition, the write data generation unit 43 outputs data for forming an exposure pattern for the dummy pits 2.

The data DT1 is supplied to the laser drive pulse generation unit 42. The laser drive pulse generation unit 42 generates laser drive pulses for actual pulse output driving of the laser source 11 on the basis of the data DT1. In other words, the laser drive pulse generation unit 42 generates a pulse waveform for laser emission at timing at which the pre-heating pulse Pp and the pulses P1 to Pn are output with intensities corresponding to the pulses in accordance with the length of a pit to be formed as shown in part A of FIG. 8.

The laser drive pulses are supplied to the laser driver 41. The laser driver 41 supplies a drive current to the semiconductor laser, functioning as the laser source 11, on the basis of the laser drive pulses. Thus, laser pulses are output at the intensities corresponding to the laser drive pulses.

The intensity monitor signal SM1 obtained from the photodetector 21 is supplied to the laser driver 41. The laser driver 41 compares the intensity monitor signal SM1 with a reference value to control the intensity of laser emission at a predetermined level.

The disk master 103 is rotated by a spindle motor 44. The spindle motor 44 is rotated while the rotational speed thereof is being controlled by a spindle servo driver 47. Thus, the disk master 103 is rotated at a constant linear velocity.

A slider 45 is driven by a slide driver 48. The slider 45 moves the whole of a base including a spindle mechanism mounting the disk master 103. In other words, the disk master 103 rotated by the spindle motor 44 is exposed by the above-described optical system while being moved in the radial direction by the slider 45, so that a track constituting a series of exposed pits is spirally formed.

The position moved by the slider 45, i.e., the exposed position of the disk master 103 (in the radial direction of the disk) is detected by a sensor 46. Information SS regarding the detected position (hereinafter, position detection information SS) obtained by the sensor 46 is supplied to a controller 40.

The controller 40 controls the whole of the mastering apparatus. In other words, the controller 40 controls the data generation operation of the write data generation unit 43, processing by the laser drive pulse generation unit 42, laser power setting on the laser driver 41, the spindle rotation control operation of the spindle servo driver 47, and the operation for moving the slider 45 by the slide driver 48.

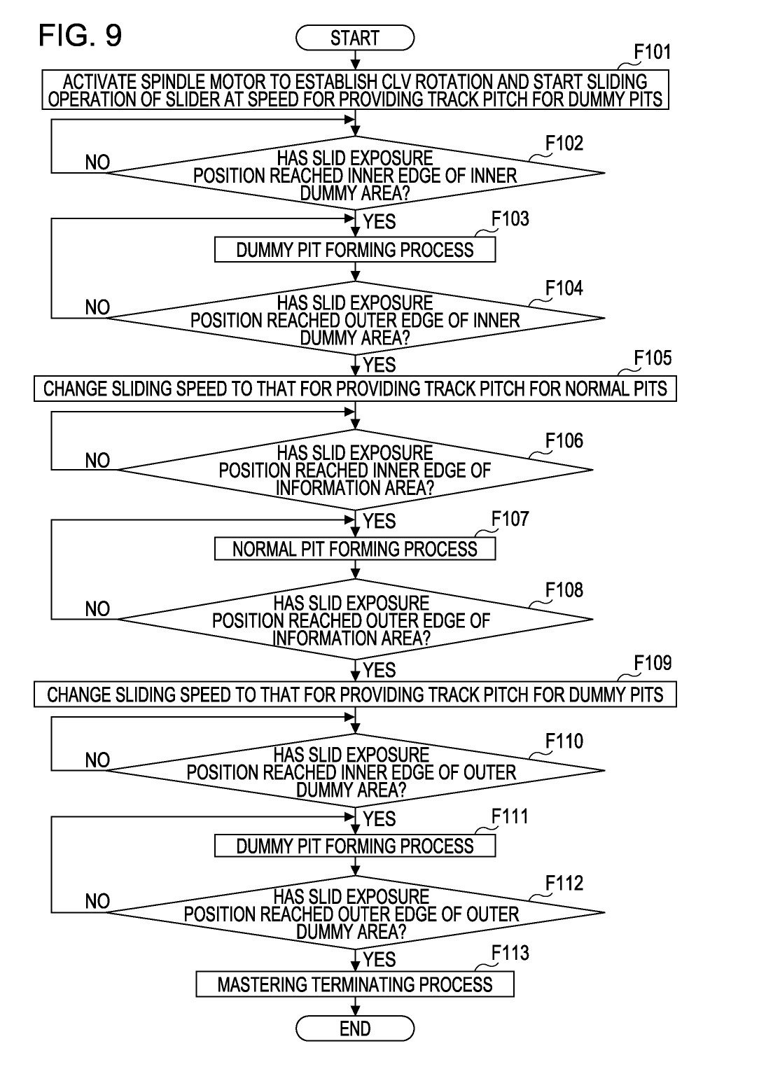

The controller 40 performs mastering processing, shown in FIG. 9, for making the stamper 104 and the optical disk according to the foregoing first example.

In starting the mastering processing, in step F101, the controller 40 allows the spindle servo driver 47 to activate the spindle motor 44, thus establishing rotation of the spindle motor 44 at a constant linear velocity. In addition, the controller 40 directs the slide driver 48 to start the sliding operation of the slider 45 at a speed for providing the track pitch (0.64 μm) for the above-described dummy pits.

In step F102, the controller 40 monitors the position detection information SS supplied from the sensor 46. The controller 40 determines whether the slid exposure position has reached the inner edge of the inner dummy area Idm, i.e., a position along a diameter of 38.0 mm of the disk master 103.

When the exposure position has reached the inner dummy area Idm, the processing proceeds to step F103. In step F103, the controller 40 performs a dummy pit forming process. In other words, the controller 40 allows the write data generation unit 43 to generate data for dummy pits. The generated data may include random data for formation of pits having lengths of 2T to 8T based on, for example, the Blu-ray Disc format specifications. In addition, the controller 40 allows the laser driver 41 to perform the laser driving operation at a higher power level than a normal operation level.

Consequently, an exposed pattern corresponding to a series of dummy pits in FIG. 2B is formed on the disk master 103.

During the dummy pit forming process, the controller 40 monitors the position detection information SS in step F104. When the controller 40 determines that the exposure position slid by the slider 45 has reached the outer edge of the inner dummy area Idm, i.e., a position along a diameter of 41.0 mm of the disk master 103, the controller 40 terminates the dummy pit forming process. The processing proceeds to step F105.

In step F105, the controller 40 directs the slide driver 48 to perform the sliding operation of the slider 45 at a speed for providing the track pitch (0.32 μm) for the normal pits in the information area. In other words, the controller 40 decreases the sliding speed.

In step F106, the controller 40 monitors the position detection information SS supplied from the sensor 46 and determines whether the slid exposure position has reached the inner edge of the information area, i.e., a position along a diameter of 42 mm of the disk master 103.

When the exposure position has reached the inner edge of the information area, the processing proceeds to step F107. In step F107, the controller 40 performs a normal pit forming process. In other words, the controller 40 allows the write data generation unit 43 to sequentially generate data to be written, e.g., physical information and management information to be written in the lead-in area, main data such as video data and audio data, and pit pattern data to be written in the lead-out area. The controller 40 allows the laser driver 41 to perform the laser driving operation at the normal power level.

Consequently, an exposed pattern corresponding to a series of normal pits in FIG. 2A is formed on the disk master 103.

During the normal pit forming process, the controller 40 monitors the position detection information SS in step F108. When the controller 40 determines that the exposure position slid by the slider 45 has reached the outer edge of the information area, i.e., a position along a diameter of 117 mm of the disk master 103, the controller 40 terminates the normal pit forming process. The processing proceeds to step F109.

In step F109, the controller 40 directs the slide driver 48 to perform the sliding operation by the slider 45 at a speed for providing the track pitch (0.64 μm) for the dummy pits. In other words, the controller 40 increases the sliding speed.

In step F110, the controller 40 monitors the position detection information SS supplied from the sensor 46 and determines whether the slid exposure position has reached the inner edge of the outer dummy area Odm, i.e., a position along a diameter of 117.5 mm of the disk master 103.

When the exposure position has reached the inner edge of the outer dummy area Odm, the processing proceeds to step F111. In step F111, the controller 40 performs the dummy pit forming process. In this case, the controller 40 allows the write data generation unit 43 to generate data for dummy pits, e.g., random data. In addition, the controller 40 allows the laser driver 41 to perform the laser driving operation at a higher power level than the normal operation level.

Consequently, an exposed pattern corresponding to a series of dummy pits in FIG. 2B is formed on the disk master 103.

During the dummy pit forming process, the controller 40 monitors the position detection information SS in step F112. When the controller 40 determines that the exposure position slid by the slider 45 has reached the outer edge of the outer dummy area Odm, i.e., a position along a diameter of 120 mm of the disk master 103, the controller 40 terminates the dummy pit forming process. The processing proceeds to step F113. In step F113, the controller 40 stops the spindle motor 44, the slider 45, and laser output, thus terminating the mastering processing.

As described with reference to FIGS. 6D, 6E, and 6F, the stamper 104 is molded using the disk master 103 made by mastering as described above. An optical disk made using the stamper 104 is the same as that described in the first example.

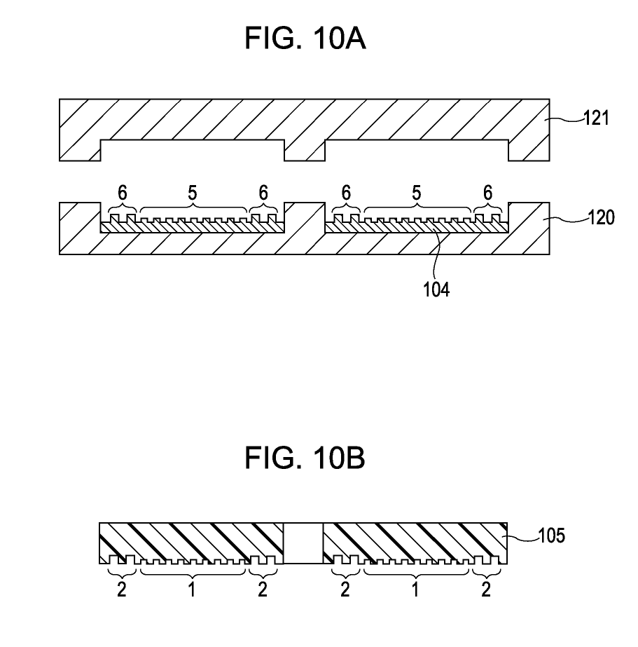

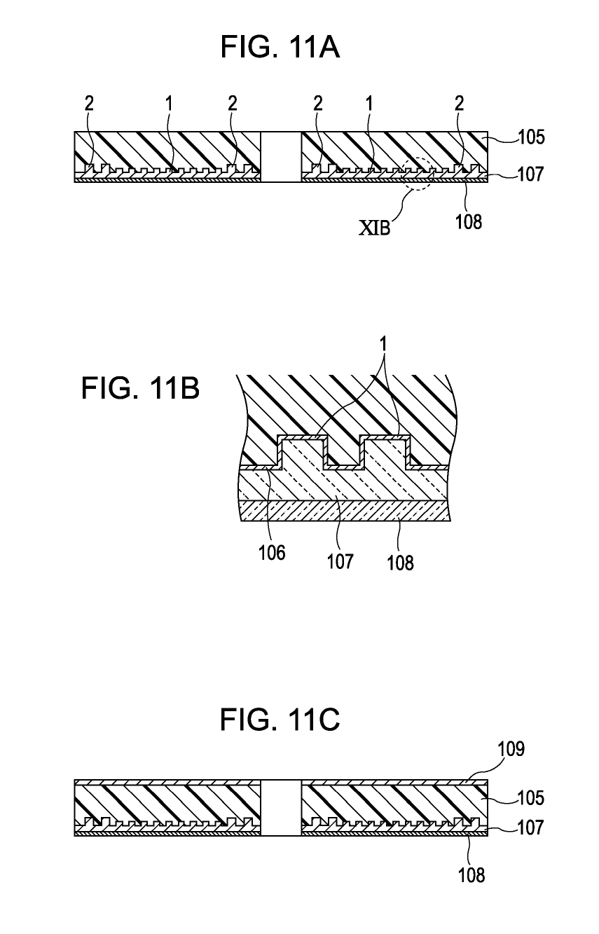

FIGS. 10A to 11C show the optical disk made in the steps shown in FIGS. 6G to 6J.

FIG. 10A schematically shows a mold used for molding the disk substrate 105 using the stamper 104 in the step of FIG. 6G.

The disk substrate 105 is molded by injection molding using a polycarbonate resin. Referring to FIG. 10A, the mold includes a lower cavity 120 and an upper cavity 121. The stamper 104 is arranged on the inner surface of the lower cavity 120.

The stamper 104, made using the disk master 103 formed by the above-described mastering processing, has the irregular pattern 5 for forming the normal pits 1 in a region corresponding to the information area and the irregular pattern 6 for forming the dummy pits 2 in regions corresponding to the outer dummy area Odm and the inner dummy area Idm, respectively.

The disk substrate 105 is molded by injection molding using the above-described mold. FIG. 10B shows the molded disk substrate 105.

Referring to FIG. 10B, the disk substrate 105 made of a polycarbonate resin has a center hole at its center and further has the normal pits 1 and the dummy pits 2 on one surface (information read-out surface) thereof, the pits 1 and 2 being formed by transferring the irregular patterns 5 and 6 on the stamper 104.

The molded disk substrate 105 is processed so as to have a layered structure as shown in FIGS. 6I and 6J. FIGS. 11A and 11B are enlarged views illustrating the layered structure.

Referring to FIG. 11B, the reflective layer 106 of, for example, a silver alloy is formed on the information read-out surface on which the normal pits 1 and the dummy pits 2 are arranged.

Subsequently, the light-transmissive layer 107 is formed by laminating a polycarbonate film or spin coating an ultraviolet curable resin onto the reflective layer 106. The information read-out surface is then subjected to surface treatment, thus forming the hard coat 108.

After that, the printing layer 109 is formed on the other surface (label surface) of the disk substrate 105 as shown in FIG. 11C. For example, offset printing is used. The whole of the label surface is covered with a white coat and is subjected to color printing, thus forming the printing layer 109.

Consequently, an optical disk is completed. The optical disk has the normal pits 1 and the dummy pits 2 shown in FIGS. 2A and 2B.

To make the stamper 104 and an optical disk in accordance with the above-described second example shown in FIGS. 4A and 4B, the mastering processing of FIG. 9 may be modified.

In the second example, the track pitch and the depth and width of each dummy pit 2 in the dummy areas Idm and Odm are the same as the track pitch and the depth and width of the normal pit 1 in the information area. Accordingly, the sliding operation started in step F101 is performed at a speed for providing a track pitch of 0.32 μm until the mastering processing is terminated. Changing the sliding speed in steps F105 and F109 is unnecessary.

In the dummy pit forming process in each of steps F103 and F111, data for forming a series of pits having a 8T length may be generated. Furthermore, increasing the laser power is unnecessary.

To form the dummy groove shown in FIG. 5, changing the sliding speed and changing the laser power are unnecessary in the same way as the second example. Exposure may be performed continuously from the inner dummy area Idm to the information area and from the information area to the outer dummy area Odm.

Another embodiment of the present invention will now be described. In this embodiment, dummy pits 2 (or a dummy groove) are formed on a surface of a disk substrate 105 in the same way as the foregoing embodiment. The present embodiment differs from the foregoing embodiment in that the disk substrate 105 is molded such that the whole of the other surface (label surface) thereof is satin finished.

Mastering processing for making a disk master 103 and a stamper 104 made using the disk master 103 are the same as those in the foregoing embodiment.

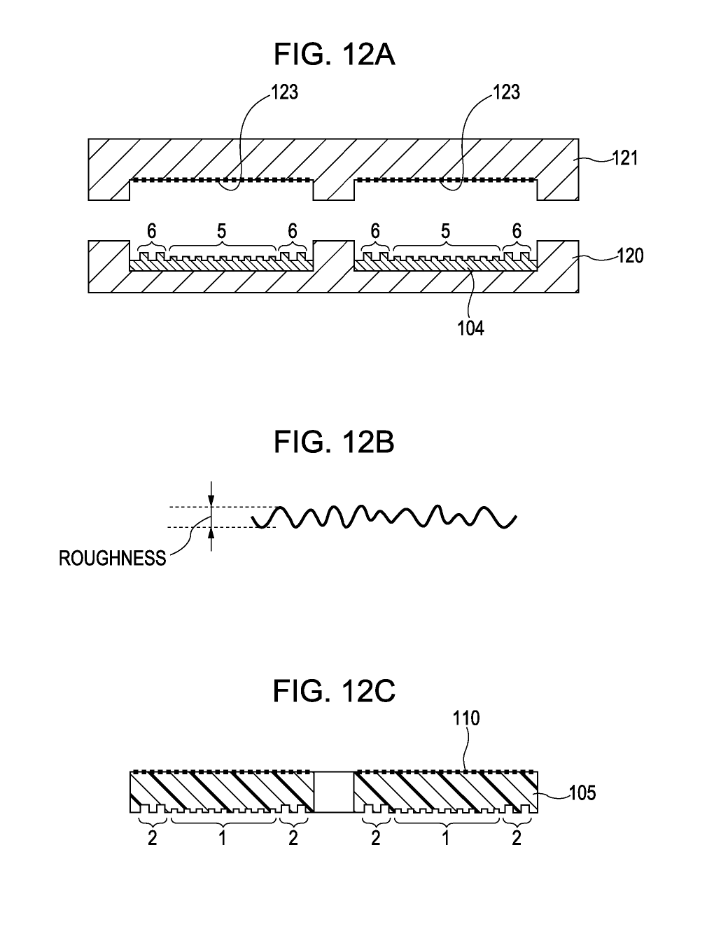

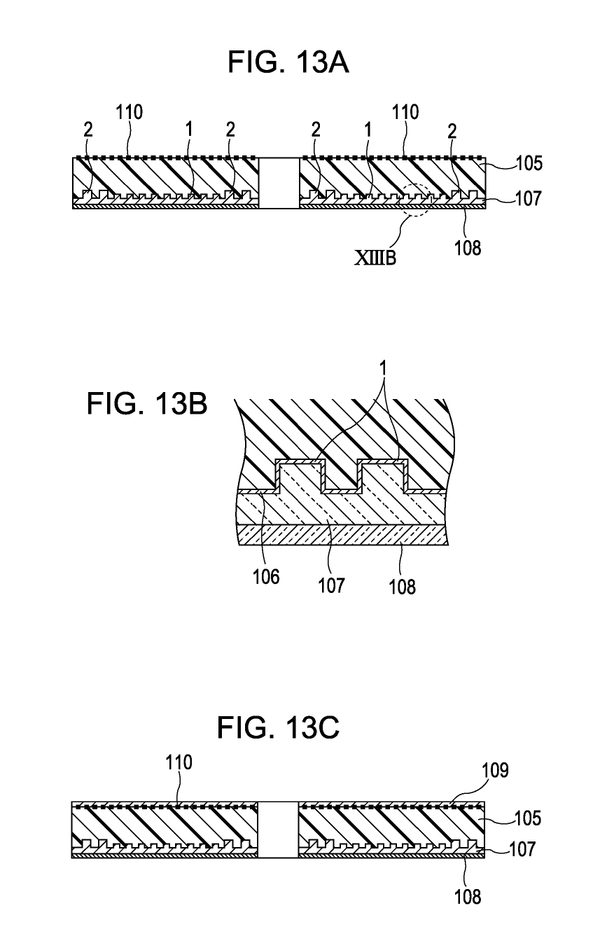

An optical disk processed in steps corresponding to those in FIGS. 6G to 6J in accordance with the present embodiment will now be described with reference to FIGS. 12A to 13C.

FIG. 12A schematically shows a mold used for molding the disk substrate 105 using the stamper 104 in the step corresponding to that in FIG. 6G.

The disk substrate 105 is molded by injection molding using a polycarbonate resin in a manner similar to the foregoing embodiment. The stamper 104 is arranged on the inner surface of a lower cavity 120 of the mold as shown in FIG. 12A.

On the other hand, an upper cavity 121 has a satin-finished surface 123 corresponding to a label surface of an optical disk to be molded.

The surface 123 can be satin finished by etching or a blaster technique using plastic beads or glass beads.

The satin-finished surface 123 has fine irregularities. As shown in FIG. 12B, the difference in level among irregularities, i.e., the roughness of the satin-finished surface 123 lies in the range of, for example, 0.5 μm to 5 μm, preferably, 2 μm to 3 μm.

FIG. 12C shows the disk substrate 105 molded by injection molding using the above-described mold.

In other words, the disk substrate 105 made of a polycarbonate resin has a center hole at its center and normal pits 1 and dummy pits 2 on the information read-out surface thereof, the pits 1 and 2 being formed by transferring irregular patterns 5 and 6 arranged on the stamper 104.

The satin-finished surface 123 of the mold is transferred to the whole label surface of the disk substrate 105, thus providing a satin-finished surface 110. In other words, the disk substrate 105 has the satin-finished surface 110 having a roughness in the range of 0.5 μm to 5 μm (for example, 2 μm to 3 μm) as the label surface.

The molded disk substrate 105 is processed so as to have a layered structure as shown in FIGS. 6I and 6J. FIGS. 13A and 13B are enlarged views illustrating the layered structure.

Referring to FIG. 13B, a reflective layer 106 made of, for example, a silver alloy is formed on the information read-out surface on which the normal pits 1 and the dummy pits 2 are arranged.

Subsequently, a light-transmissive layer 107 is formed by laminating a polycarbonate film or spin coating an ultraviolet curable resin onto the reflective layer 106 as shown in FIGS. 13A and 13B. The information read-out surface is then subjected to surface treatment, thus forming a hard coat 108.

After that, a printing layer 109 is formed on the other surface (label surface) of the disk substrate 105 as shown in FIG. 13C. For example, offset printing is used. The whole of the satin-finished label surface is covered with a white coat, thus planarizing the satin-finished label surface. The planarized surface is subjected to color printing, thus forming the printing layer 109. Since the fine irregularities on the satin-finished label surface are not exposed after printing, the planarized surface serves as a printing surface.

Consequently, an optical disk is completed. The optical disk has the normal pits 1 and the dummy pits 2 shown in FIGS. 2A and 2B.

As described above, the stamper 104 has the irregular pattern 6 for forming the dummy pits 2, thus preventing pit tailing caused when the disk substrate 105 is released from the stamper 104 and is removed from the mold.

In the present embodiment illustrated in FIGS. 12A to 13C, the label surface of the disk substrate 105 is satin finished using the satin-finished surface 123 of the upper cavity 121 of the mold. This arrangement effectively prevents pit tailing. In other words, since the inner surface of the upper cavity 121 of the mold serves as the satin-finished surface 123, the appropriate degree of contact between the disk substrate and the mold is obtained during molding of the disk substrate using the mold and the stamper 104. Advantageously, the satin-finished surface acts so as to prevent pit tailing caused by shrinkage of the resin in the mold during cooling or upon releasing a mold clamping force.

In actual manufacture, the following fact was confirmed: When the roughness of the satin-finished surface is set to 0.5 μm or more, pit tailing can be more effectively prevented.

In the present embodiment described with reference to FIGS. 12A to 13C, the effect of preventing pit tailing by means of the dummy pits 2 (formed by the irregular pattern 6 of the stamper 104) on the information read-out surface of the disk substrate 105 and the effect of preventing pit tailing by means of the satin-finished label surface 110 (formed by the satin-finished surface 123 of the upper cavity 121) of the disk substrate 105 are synergistically exerted, allowing for more stable manufacture of disks.

A read-only optical disk molded in this manner was played in order to measure jitter. A low jitter of 5.5% or lower was measured over the whole disk. That is, an excellent result was obtained. A deterioration in characteristics of read signals caused by pit tailing of the normal pits 1 in the information area was not found. Furthermore, a sampling inspection was performed on 10,000 optical disks successively molded in order to recognize molding stability. There was no deterioration in jitter.

In addition, the following fact was found: Even when the dummy pits 2 are omitted and the label surface of the disk substrate is processed using the satin-finished surface 123 of the upper cavity 121 to provide the satin-finished surface 110, the same advantages of preventing pit tailing as that in the use of the dummy pits 2 are obtained.

Since the satin-finished label surface 110 is planarized using the white coat before printing, there is no influence of the satin-finished label surface upon printing. The disk substrate has the planarized printing surface to provide a smooth and good appearance in the same way as normal disk substrates. Accordingly, the commercial value of the disk substrate having the satin-finished label surface is not reduced.

Particularly, since the roughness of the satin-finished surface is in the range of 2 μm to 3 μm (below at least 5 μm), the label surface can be easily planarized using the white coat.

The white coat is used in a normal printing process to realize excellent color development of ink and ink fixation upon printing. The white coat is not specially used to cover the satin-finished surface in the present embodiment. In other words, the number of steps for printing is not increased in the present embodiment.

The embodiments of the present invention have been described. The present invention is applicable to a multilayer disk including two or more layers.

Furthermore, the present invention is applicable to various optical disks, such as a Blu-ray Disc, a DVD, and a CD.

It should be understood by those skilled in the art that various modifications, combinations, sub-combinations and alterations may occur depending on design requirements and other factors insofar as they are within the scope of the appended claims or the equivalents thereof.

What is claimed is:

1. A stamper for making a read-only optical disk, comprising:
an irregular pattern for forming embossed pits based on recording information, the irregular pattern being arranged in a region corresponding to an information area for recording information in the read-only optical disk; and
an irregular pattern for forming dummy irregularities, the irregular pattern being arranged in a region corresponding to an area between the information area and the outer periphery of the disk.

2. The stamper according to claim 1, wherein the irregular pattern for forming the dummy irregularities is arranged in a region corresponding to an area between the information area and the inner periphery of the disk.

3. The stamper according to claim 1, wherein
the dummy irregularities formed on the read-only optical disk are dummy pit strings, and
the irregular pattern for forming the dummy irregularities is designed such that each dummy pit of the dummy pit strings has a depth greater than that of each embossed pit in the information area and the track pitch between the dummy pit strings is wider than that between embossed pit strings in the information area.

4. The stamper according to claim 1, wherein
the dummy irregularities formed on the read-only optical disk are dummy pit strings, and
the irregular pattern for forming the dummy irregularities is designed such that dummy pits of the dummy pit strings are each an embossed pit having a predetermined length.

5. The stamper according to claim 1, wherein the irregular pattern for forming the dummy irregularities is designed so as to provide a dummy groove in the read-only optical disk.

6. A read-only optical disk on which information is recorded using embossed pits in an information area for recording information, the disk comprising:
dummy irregularities arranged between the information area and the outer periphery of the disk.

7. The read-only optical disk according to claim 6, wherein the dummy irregularities are arranged between the information area and the inner periphery of the disk.

8. The read-only optical disk according to claim 6, wherein
the dummy irregularities are dummy pit strings,
each dummy pit of the dummy pit strings has a depth greater than that of each embossed pit in the information area, and
the track pitch between the dummy pit strings is wider than that between embossed pit strings in the information area.

9. The read-only optical disk according to claim 6, wherein
the dummy irregularities are dummy pit strings, and
dummy pits of the dummy pit strings are each an embossed pit having a predetermined length.

10. The read-only optical disk according to claim 6, wherein the dummy irregularities provide a dummy groove.

11. The read-only optical disk according to claim 6, wherein
the embossed pits and the dummy irregularities are arranged on a first surface of a disk substrate of the disk,
a second surface of the disk substrate is satin finished,
a reflective layer and a light-transmissive layer are arranged on the first surface, and
a printing layer is arranged on the second surface.

12. The read-only optical disk according to claim 11, wherein the roughness of the satin-finished second surface is in the range of 0.5 μm to 5 μm.

13. A method of making a read-only optical disk, comprising the steps of:
(a) producing a disk master such that an irregular pattern for embossed pits based on recording information is formed in a region corresponding to an information area for recording information in a read-only optical disk and an irregular pattern for dummy irregularities is formed in a region corresponding to an area between the information area and the outer periphery of the disk;
(b) producing a stamper using the disk master; and
(c) producing a read-only optical disk using the stamper.

14. The method according to claim 13, wherein the step (a) includes the substeps of:
producing a disk substrate using a mold having a first segment and a second segment, the first segment having an inner surface on which the stamper produced in the step (b) is arranged, the second segment having an inner surface that is satin finished;
forming a reflective layer and a light-transmissive layer on a first surface of the disk substrate, the first surface having the embossed pits and the dummy irregularities; and
forming a printing layer on a second surface of the disk substrate, the second surface being satin finished.

15. The method according to claim 14, wherein the roughness of the satin-finished inner surface of the second segment of the mold is in the range of 0.5 μm to 5 μm.
